(19) United States
(12) Patent Application Publication
(10) Pub. No.: US 2005/0149406 A1
(43) Pub. Date: Jul. 7, 2005

(54) Method for automated direct marketing

(76) Inventors: Michael R. Bascobert, Clarkston, MI (US); Paul J. Bascobert, New York, NY (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 11/056,779

(22) Filed: Feb. 11, 2005

Related U.S. Application Data
(62) Division of application No. 09/804,832, filed on Mar. 13, 2001, now abandoned.
(60) Provisional application No. 60/207,657, filed on May 26, 2000.

(51) Int. Cl. G06F 17/60

(52) U.S. Cl. 705/14

(57) ABSTRACT

A method for generating mailers to be delivered to members contained on a contact list comprises the following steps. A contact list and a mailer are first uploaded into a computer system. The contact list contains a listing of a plurality of members. The list is modified with marketing tools. A direct marketing campaign is next executed. The campaign disseminates information contained in the mailer to members listed in the contact list. The list and preferably the mailer are then maintained as stored in the computer system.

### RELATED APPLICATIONS

This application is a Divisional of application Ser. No. 09/804,832, filed Mar. 13, 2001, which also claims priority under 35 U.S.C.§119(e) to U.S. Provisional Application No. 60/207,657 filed on May 26, 2000.

### FIELD OF THE INVENTION

The present invention relates to a method for automated direct marketing and, more particularly, a method for automated direct marketing that allows a user to create, store, edit and disseminate a direct marketing campaign through automation.

### BACKGROUND OF THE INVENTION

Presently, direct marketing provides individuals and companies a personal and effective method to target and reach desired consumers for selling their products. Direct marketing typically involves obtaining a list of customers prone to purchasing the users products, creating a letter or brochure into an envelope and mailing to each of the listed customers. While this method had provided a successful marketing strategy for companies, the manual labor associated with compiling lists, stuffing envelopes and mailing brochures can be time consuming and costly. To eliminate this manual labor, some companies, such as National Mailing Services, provide full service direct marketing, wherein the user sends the company their contact list, and the marketing company handles all facets of executing a direct marketing campaign. Although this service eliminates much of the manual labor associated with direct marketing, it is costly. Moreover, this type of company takes full control of the list and mailer allowing for little input by the company or individual for whom the direct marketing campaign is being executed.

To overcome these drawbacks, certain automated companies such as Eletter.com and Digitalwork.com provide an automated solution to the above described drawbacks. Specifically, in each of these companies, a user first uploads a list to the company. Next, the company executes a direct marketing campaign to members contained on the uploaded list. While this system is beneficial and allows the user to retain more control over their direct marketing campaign than more traditional methods, these companies provide no maintenance of the list in their computer system or at their site. As a result, these automated companies are unable to provide many of the tools for modifying and enhancing mailing lists that are used by the more traditional companies.

Specifically, the success or failure of marketing campaigns is often based on use of an adequate or inadequate list. Adequate lists are obtained by applying suites of marketing tools and updating the mailing list based on the success or failure of previous direct marketing campaigns. Such software suites update names and addresses of members on a particular mailing list; sort lists according to demographics, income and other features; and provide other features that allow a user to more effectively target their specific audience. Users update lists based on prior marketing campaigns by eliminating members who do not purchase, focusing on member names who do purchase, and sorting members based on feedback (such as surveys) from members on the list. After years of honing, based mostly on historical results and application of software suites, a company creates a valuable list that can either be used in the user's business or sold for a high price. However, software suites required to modify lists are expensive and therefore not readily available to smaller users. Likewise, modifying a list based on results of a previous marketing campaign is costly and time consuming. The present invention was developed in light of these drawbacks.

### SUMMARY OF THE INVENTION

In accordance with the broad teachings of this invention, a method for generating mailers to be delivered to members contained on a contact list comprises the following steps. A contact list contains a listing of a plurality of members. The list is stored at the computer system. A direct marketing campaign is next executed. The campaign disseminates information contained in the mailer to members listed in the contact list. The list and preferably the mailer are then maintained as stored in the computer system for future execution of direct mail campaigns. By maintaining the list in the computer system, such as a web site back end, many users can collectively use more expensive software suites contained on the system. Likewise, because the list is maintained at the site, future direct marketing campaigns can be easily executed therefrom without list upload every time a direct marketing campaign is executed. Also, by maintaining the list in the computer system, the list can be modified, by access by a user or automation provided at the site, to generate a higher quality and more effective list.

In another aspect of the present invention, the contact list and mailer are first uploaded into a computer system. The contact list is provided containing a listing of a plurality of members. The direct marketing campaign is next executed. The contact list is then modified based on feedback from the campaign.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a schematic view of a method for automated direct marketing according to the present invention;

FIG. 2 is a block diagram of a method for automated direct marketing according to the present invention;

FIG. 3 is a block diagram of a method for automated direct marketing according to the present invention;

FIG. 4 is a block diagram of a method for automated direct marketing according to the present invention;

FIG. 5 is a block diagram of a method for automated direct marketing according to the present invention; and

FIG. 6 is a block diagram of a method for automated direct marketing according to the present invention.

### DETAILED DESCRIPTION OF THE PREFERRED EMBODIMENTS

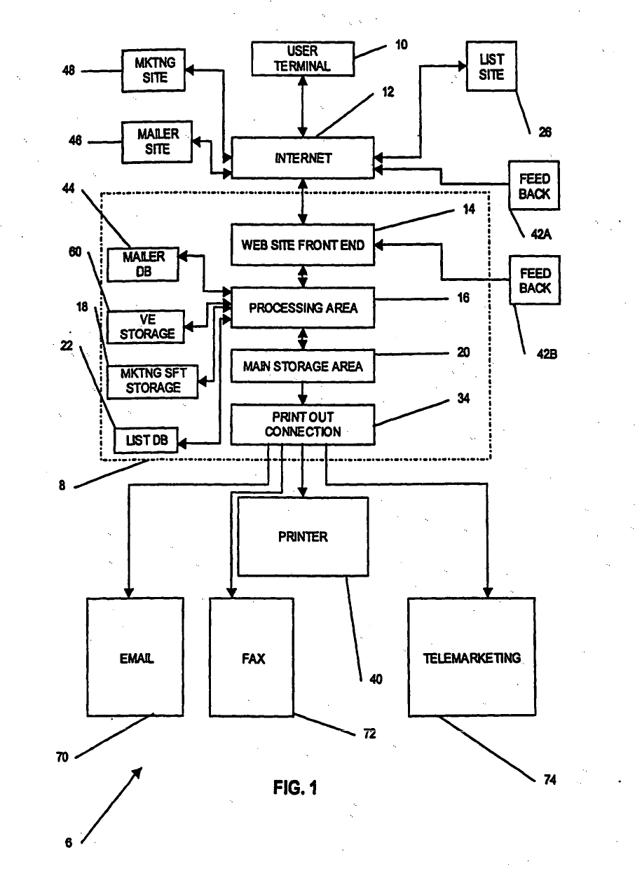

Referring now to FIG. 1, a direct marketing system 6 is shown and described. In FIG. 1, the direct marketing system 6 generally comprises computer system 8 and external components connected thereto (as will be discussed).

Computer system 8 is either a series of networked computers or one stand-alone unit. Computer system 8 preferably has a web site front end 14, which displays certain visual characteristics for users who connect to computer system 8 from remote terminals, such as remote terminal 10. Such characteristics include operational icons, which allow users to actuate various functions of computer system 8 (as will be discussed). Moreover, front end 14 acts as an interface for external devices such as remote terminal 10, mailer web site 46, marketing software web site 48. and Internet list web site 26. This connection allows computer system 8 to interface with, upload and download information to and from, and generally communicate with each of these sites.

Remote terminal 10 is one computer or plurality of networked computers which communicates with computer system 8 through a network, preferably through the internet 12. A user is any company, company agent, individual or other entity who uses remote terminal 10 to access computer system 8 to execute marketing operations contained therein.

Web site front end 14 interfaces with processing area 16, which acts as a central processing area for the operational functions of computer system 8. Processing area 16 preferably has a processor and random access memory for accessible storage and processing of data contained in the hereinafter-described databases, as well as contained within external databases that communicate with computer system 8 through network connection, such as internet 12. Besides front end 14, processing area 16 interfaces with main database storage area 20, feed back device 42, marketing software storage area 18, mailer format storage 44, print out download connection 34, feedback device 42A and list storage area 22 to retrieve and store data as will be described.

Marketing software storage 18 contains marketing tools, which comprise a plurality of software packages, allowing a user to modify, process and manipulate contact lists. Such software packages modify contact list content based on demographics, surveys, age groups and other information. Any or all of these software packages are loadable to a processing area, such as processing area 16, for use by a user at remote terminal 10 or the computer system 8. Such software packages are well known in the art. Accordingly, a detailed description of such packages is omitted. In operation, software from marketing software storage 18 is uploaded into a processing area, such as processing area 16, with a respective contact list from any storage area described herein. The list is then, responsive to a user through remote terminal 10 or by computer system 8, modified or altered. The altered list is then stored in main database storage area 20.

List storage area 22 contains contact lists, uploadable to a processing area, such as processing area 16 (as will be discussed). Each contact list contains a plurality of members having similar characteristics. These members include companies, organizations, or individuals. In one aspect, each list contains only member names and address information. Such a contact list preferably has corresponding address fields, which include a listing of mailing addresses, phone numbers, fax numbers, email addresses or other information which identifies an address which can be used to contact a member. The members contained on each list are limited to those with similar characteristics. For instance, such members might be directed toward a particular industry, such as a listing of insurance companies. In operation, a user, from remote terminal 10, connects to list storage area 22, selects a specific topic or industry for which the user is desirous of acquiring a contact list. The user can also conduct a key word or other search of list storage 22 to obtain a more focused list. List storage 22 them provides a display to remote terminal 10, through processing area 16 and front end 14, which provides a listing of contact lists for the selection. The user then selects the desired list, at which point the list is copied or moved to the user's allocated storage area (as will be discussed).

In another aspect, each member listing for a broad contact list in list storage area 22 contains a host of characteristics searchable by a user form remote terminal 10. Such characteristics include, but are not limited to, buying habits, age group, interests, hobbies, location, demographic or other information useful to a marketing company or individual designing or executing a direct marketing campaign. Each characteristic is contained in a field associated with the respective member. As described above, addresses including mailing address, phone numbers, fax numbers or email address of respective members are provided for each member. Accordingly, such names and characteristics are preferably searchable by a user from remote terminal 10. From remote terminal 10, the user uploads the selected contact list, chosen as discussed above, into processing area 16. The user then executes a search, by instructing computer system 8 from remote terminal 10, to search specific fields for specific characteristics. Such a search, for example, might include searching for members located in one specific geographic location. After executing the search, processor 16 outputs a modified contact list limited to the selected search criteria. The user then instructs computer system 8 to load the modified list into their allocated storage area.

Each list preferably contains comment fields accessible by any user who desires to provide comments regarding the specific list. Such comments might include the user's success, failure or general opinions on the quality of the list. Such fields are searchable as described above. Thereby, each user can review a specific list and read comments in the field before deciding to use the specific list.

List storage area 22 is accessible by external users, such as remote terminal 10, through web site front end 14 to allow external users to place contact lists in list storage area 22 for brokerage, sale or gift. To effectuate such a transfer, a user connects to web site front end 14 and uploads their contact list to list storage area 22. The contact list is stored with seller and price information as associated fields, which the list owner enters. Users connecting to web site front end 14 are able to review certain aspects of the list, and if desired, effectuate a sale, rental or other upload of the list from list storage area 22 to main database storage area 20 or to remote terminal 10. Such methods for purchasing items on line are well known and disclosed for instance in U.S. Pat. No. 5,794,207 assigned to Walker Asset Management Limited Partnership, and hereby incorporated by reference.

As a result of the above described process, external users can contact list storage area 22, through web site front end 14, and upload either lists brokered on list storage area 22 or those posted by computer system 8 to their respective accounts in main database storage area 20.

For the purpose of this invention, a direct marketing campaign includes any mass contact of any or all or the members contained on a contact list for a common and particular purpose. Such a purpose includes sale of a user's product or services. Likewise, such purpose includes dissemination of information for a club or organization. Such purpose also includes sending holiday or occasion correspondence, such as Christmas or birthday cards. The information to be disseminated is preferably common among all the members targeted for the direct mailing campaign, such that one mailer with slight modification can be disseminated to each member contained on the mailing list.

Mailer format storage 44 contains a plurality of pre-selected mailer formats, uploadable by remote terminal 10 for modification or manipulation. Such manipulated mailers then can be used as a user's mailer for dissemination with a direct marketing campaign. Mailer formats are designs, useable by a marketing company or individual desirous of designing a mailer, which includes flyers, brochures, pamphlets, telemarketing speeches, email or other formats for use in a direct marketing campaign. Such mailer formats preferably contain a host of clip art, border design, text layout and other features that a user from remote terminal 10 selects and customizes for their own personal business use. Once selected and modified, the user then moves the modified mailer to a storage area, such as main database storage area 20. Here, the modified mailer can be used in conjunction with a stored list, as described above, to effectuate a direct marketing campaign.

Mailers can also be designed for dissemination through telemarketing (as will be discussed). Here, the mailer contains a sales speech, which is to be orally disseminated by the telemarketing group. Such a mailer contains a listing of statements geared to a particular industry. For example, a mailer geared toward aspirin may contain a statement such as “do you realize aspirin has been determined to help reduce heart attack risk.” The user tailors the mailer to their specific company or products by modifying the mailer with their company name, corporate information etc.

To use mailers from mailer storage area 44, a user from remote terminal 10 selects a mailer format by using the same procedures as disclosed for contact lists in list storage 22. The mailer format is then loaded into processing area 16. Here, the user from remote terminal 10 modifies the mailer by putting personal information therein. For example, the body of the mailer format might contain a general sales pitch useable for many users in a particular industry. The user, in processing area 16 modifies this general format by placing the company name and the user's specific product information in the mailer. The modified mailer, by a request from the user at remote terminal 10, then instructs computer system 8 to return the modified mailer to their respective allocated storage area in main database 20. The modified mailer, stored in association with a user's contact list, can be used to execute a direct marketing campaign by computer system 8.

Main database storage area 20 contains allocated storage areas for storing company marketing information. Company marketing information includes a combination such as contact lists, mailers or company information. Storage area 20 contains a plurality of allocated storage areas. Each allocated storage area is addressed for a respective user to which the allocated storage area is allocated. Such addressing includes any conventional type of addressing structure, including general file names containing all information for a respective user or any other structure which links the user's company marketing information stored in main database storage area 20 with a respective user. As such, each allocated storage area is accessible by the respective user who maintains their list in the allocated storage area of main database storage area 20. Such accessibility includes at least the ability to repeatedly instruct the computer system 8 to execute direct mailings at different times with the list stored in main database 20 in the respective allocated storage area. For instance, a user can access the stored list from remote terminal and request execution of a direct marketing campaign on a different day or time than when a contact list is uploaded. As such, the user can execute multiple direct marketing campaigns without being required to upload a list each time the direct marketing campaign is executed.

Accessible storage also preferably, but not necessarily, includes the ability for a user from remote terminal 10 to upload the user's list from main database storage area 20 into a processing area, such as processing area 16 or a processing area located at remote terminal 10. The user then manipulates, changes member names or associated fields, adds member names or information in associated fields, and returns the modified contact list into the user's allocated storage area in main database 20. Such allocated storage maintains the user's contact list in main database storage area 20, such that the user can access their respective list from remote terminal 10.

Preferably, each storage area not only contains the mailer and contact list of a particular user, but also contains company information for the particular user, but also contains company information for the particular user or user's business for which direct marketing is being executed. Such information can include, but is not limited to, profits, product type, direct mailing history, particular mailing request requested by the user (as will be discussed) and other pertinent information which would allow a marketing agent to design a more effective marketing campaign. This information is uploaded from a user at remote terminal 10 directly into an allocated storage area in main database 20.

As described above, product type indicates the type of products or services currently offered by the user. Direct mailing history provides a history of any number of fields, including when the company executed a direct marketing campaign, who were the designated recipients of mailings, and success or failure of such marketing campaign represented by feedback information (as will be discussed). Particular mailing requests include a future history of when, to whom, and how a user would like an executed direct mailing campaign to be effectuated. More specifically, a user can specify that a direct mailing campaign be executed on a particular day every month, choose selected members of their contact list to be targeted with the direct mail campaign, and specify a specific mailer for each executed campaign.

Printer connector 34 acts as a conduit between computer system 8 and printer 40, email 70, fax 72, and telemarketing group 74. Printer 40, email 70, fax 72, and telemarketing group 74 constitute methods for dissemination of a direct marketing campaign from computer system 8. Printer connector 34 contains a processor with processing capabilities similar to those discussed for processor 16 and any required software to allow computer system 8 to associate a contact list contained in main database storage area 20 with a respective mailer to disseminate mailings for a direct marketing campaign. When compiling, printer connector 34 uploads a specific contact list and associated mailer from main database 20 and sends this information to one of the dissemination devices described herein.

Printer connector also acts to place specific field information for each specific member on respective mailers sent to the respective member. For instance, the member name information contained in the name field is printed on each respective printed mailer, such that each member who receives the mailer sees their name on the mailer. Other similar field information can similarly be printed on the mailer.

With respect to printer 40, print connector 34 either transfers printing information directly to printer 40, or records information on portable storage medium, such as floppy disc, for manual transportation to printer 38. The printer 38 then prints the mailer and associated envelopes for dissemination through a postal service. As such, each of a plurality of hard copy mailers are printed with address information of the respective member on the contact list. The printed mailers are then disseminated through a postal service such as the U.S. Mail, Federal Express or any other known method.

Email connection 70 and fax connection 72 provide a connection for computer system 8 to disseminate a mass emailing or facsimile. Once again, print out download connector 34 compiles the mailer information and the contact list such that fax machine 72 or email device 70, or a user operating any of these machines, can identify which mailer goes with which contact list. The fax machine or email server, which sends the mailers, then sends a plurality of mailers to each respective email address or fax number associated with a specific mailer. As with the printer, the email connection or fax connection lists selected field information in the email or fax that corresponds to the respective member to which the mailer is being sent. As advanced graphics is not always desirable in email or fax format, mailer information here for fax or email, if desired, can be stored in main database storage area as text. As such, multiple mailers can be stored in main database 20. Each mailer for different type of dissemination method.

Telemarketing connection 74 preferably contains a link to a telemarketing group. Such a group preferably consists of either a single individual, or a plurality of individuals who specialize in directly contacting individuals by phone. Telemarketing connection 74 preferably transmits the mailer and associated contact list directly to the telemarketing group. The telemarketing group then personally contacts members on the list and gives a sales speech substantially reflecting what is presented in the mailer format. As such, individuals can customize their telemarketing speech as they like by presenting the mailer in a format reflecting a series of questions or other oral dissemination of information. For instance, the mailer format for a telemarketing group can include a listing of statements the user desires the telemarketing group to say to a particular member.

Marketing software website 48 contains marketing software similar to that contained by marketing software storage 18. Likewise, Mailer website 46 contains a plurality of mailer formats, similar to mailer format storage 44. Lastly, internet list site 26 contains a plurality of contact lists, similar to list storage 22. However, these sites link to computer system 8 by traditional linking arrangements through internet 12 to computer system 8, instead of directly to processor 16 as previously described. As such, to use information from any of these sites, a user links to the respective site, through website front end 14, then downloads the selected list, mailer, or marketing software to either processing area 16 or main database storage area 20. For the purpose of this application, the term download indicates movement, copy or any other electronic transfer of data or information from one location to another.

Feedback device 42A and 42B provides feedback information to computer system 8 that represents the success or failure of an executed mailing campaign. Such information is based on each member's response to receiving the mailer from the direct marketing campaign. Such response is reported through feedback device 42A or 42B to computer system 8. Computer system 8 then processes this information into a format useable by the user who executed the direct marketing campaign.

In one aspect, each member listed on the user's contact list contains fields for recording feedback information. These fields are listed for each member, such that each member's feedback is recorded and associated to that member. Alternatively, the field can be only associated with a particular direct marketing campaign. Then, the overall results, such as number of people purchasing or responding, is recorded in the respective field. Computer system 8 marks this field based on the feedback received from a direct marketing campaign. In either approach, the feedback received from a direct marketing campaign. In either approach, the feedback results are provided to the respective user, used to update the respective contact list or used to update other company marketing information. The fields can contain positive or negative feedback representing the member's purchase, non-purchase, positive response or negative response to a product or customer survey. The feedback can be the fact that the member did not respond at all to the direct marketing campaign. The feedback can also represent the member's response to the particular mailer format that was disseminated to them. Such opinions can be used in future direct marketing campaigns to determine whether that particular member should or should not be added to a direct marketing campaign. This information can also be reviewed by an agent program, as will be discussed. The user can also process the contact list with the feedback information to ensure that future direct marketing campaigns are directed to only customers with positive feedback, or that only specific mailer formats go to specific members. Such processing includes instructing computer system 8 to sort positive feedback customers and store only the positive feedback customers as a modified list.

Alternatively, the information is tabulated or organized into a report format indicating overall results of a marketing campaign similar to those discussed above. Such reports may include customer comments, whether the customer liked the mailer, whether the member dislikes receiving direct mail, whether the customer desires to purchase the user's product, whether the customer has purchased the user's product or any similar information. Computer system then organizes this information into a report format. Such format can include overall results or results for each member. These results are then reported to the user, at remote terminal 10 or through any of the dissemination methods disclosed herein. Alternatively, the results are stored in the user's allocated storage area in main database 20 for accessible retrieval by the user.

Such feedback is also used to update specific fields for the user's contact list. Specifically, the feedback can be in the form of requesting the member to provide new address or other related information. Computer system 8 can then update the associated field in the contact list with the new information.

Feedback information can be gathered through a host of methods. Such methods include using a telemarketing group, who enters feedback through the feedback devices in response to success or failure of their teleconference with respective members of a contact list. In this instance, the telegroup electronically communicates with computer system 8 through feedback device 42A or 42B. Such communication is preferably from a remote terminal used by the telegroup. The telegroup enters information representing a successful hit or failure with a particular member of a contact list, through feedback device 42B or 42A, to the field associated with the member in the user's contact list, stored in main database storage area 20. The field then reflects the members response to the contact by the telegroup.

Such feedback may also be in the form of information read directly from a user's cash register or other electrical device located at the users store. Specifically, in this situation, the user's credit card machine communicates with feedback device 42A through an internet connection 12. In response to a member's name or a new customer (not yet a member of a contact list) effectuating a purchase, the credit card machine communicates this purchase computer system 8 which updates an associated field in the user's contact list. Thereby, the new customer can be entered as a members, or if already a member, the purchase habits or history is recorded in fields associated with the particular member.

In another aspect, each mailer disseminated from printer 34 is fitted with a bar code, questionnaire or other scannable information. The mailer can also be in the form of a survey, completed by the member and returned. Some members mail the mailer back to the user or to the computer system 8 to purchase of the user's product, obtain a rebate or other known mail back techniques. Either the user or individuals at computer system 8 scan the bar code or other scannable information, or manually enter respective information indicating the member's response to the mailing into computer system 8. The scannable information also contains an address code which represents the specific member, direct marketing campaign of user for which the campaign was executed. Upon reading this information, computer system 8 then records this information as provided above.

In another aspect of the present invention, the feedback information is received by computer system 8 as a reply email in response to a mass emailing. Here, each disseminated email has an address code contained therein. The address code represents the specific member, direct marketing campaign or the specific user who executed the direct marketing campaign. The member responds to the email by answering questions or responding with written comments to the email. The reply is received by computer system 9, which identifies the specific user to which the email was sent. Computer system 8 then updates that member's listing in the contact list as described above.

Virtual employee storage 60 contains agent software for use in computer system 8. Agent software either passively responds to user requests or actively makes decisions based on a particular companies company marketing information which includes the contact list, company information, mailer and/or external input information. Such external input information includes a listing of holidays, marketing tips, new lists or other information not contained within an allocated storage area of a particular user. In one aspect, the agent software, having recorded holiday and other important sales dates, contacts the user and prompts the user execute a mailing. Such important sales dates include any dates which a particular user would benefit from executing a direct marketing campaign. For instance, the agent software may prompt the user by saying “its Christmas, want to send a mailing, just hit go if you would like.” Christmas is an important sales date for sellers of toys and gifts. If the user accepts, the agent program then processes the user's contact list and mailer through print out connection 34 to execute a direct marketing campaign as described above. Of course, the agent program also prompts the user to select which method of dissemination the user would like to use.

Moreover, the agent program can suggest a specific mailer, such as Christmas cards for the Christmas example above. Upon the user's acceptance, the agent program associates the Christmas card mailer from mailer format storage database with the user's contact list. Upon acceptance by the user, the agent program executes a mailing and sends Christmas cards to each member of the contact list.

Similarly, the agent program reviews mailer history (i.e. when and to whom the last mailings were sent) and feedback information from past mailings (i.e. successful and non-successful hits), which is stored in main database 20. The external input, here, is programming instructing the agent program how to deal with or identify issues with the company marketing information. In one aspect, the agent program prompts the user and says “I have been reviewing your customer feedback and Mr. X has bought a lot of zigzags. Would you like to modify your list and add him as a high priority customer?” If the user responds with “yes”, the agent program then updates the contact list in the main database storage area 20 to reflect Mr. X as a high priority customer. Or, if Mr. X has not made any purchase of the user's product, the agent program suggests that Mr. X is removed from the contact list. If the user responds “yes”, computer system 8 removes Mr. X from the contact list.

In another aspect, the agent program is responsive to input at the computer system 8. For instance, in response to a marketing tip for a particular type of industry input into computer system 8, the agent program scans the company marketing information, contact list and mailer of each user in main data base storage area 20. The agent program then identifies and prompts relevant users and says “our marketing experts have found an interesting marketing approach useful with your type of business, would you like to modify your mailer accordingly”? Such marketing approach might include a sales pitch which has yielded successful results for other users in the same business field, new contact list, or advice on selling a particular product or service. If the user accepts, the agent program then modifies the mailer or contact list for the user in main database 20 accordingly, or the agent program disseminates the information to the user through any method disclosed herein such as mail, email, phone or fax.

In another aspect of the invention, the agent program runs regular marketing software programs or marketing tools stored on marketing software storage area 18. For instance, the agent program, after running an address update program, prompts the user and says “We have run a routine address correction on your contact list, would you like me to update your list accordingly?” If the user responds “yes”, the agent program then updates the list stored in main database storage area 20.

In another aspect, the agent program is responsive to user input. For instance, the agent program communicates with other electrical devices at a user's place of business. Such electrical devices include cash registers, photo copiers, fax machines and scanners. The communication is effectuated through remote terminal 10, through website front end 14 and to processing area 16. For instance, the agent program, responding to a user's cash register communication, says, “the cash register in your store has told me that Mr. X has purchased a lot of widgets, would you like me to add him to your contact list?” If the user responds “yes” through remote terminal 10, the agent software updates the user's contact list accordingly.

In the above and below described agent program operations, the agent program contacts the user either when the user logs onto their account, through email, or from computer system 8 to remote terminal 10 or other disclosed dissemination method herein. An electronic response by a user from remote terminal 10 acts as an execution command to execute the desired function by computer system 8.

In another aspect of the invention, the agent program scans company information in main database storage area 20 and provides the user with information valuable to his line of business. For instance, the agent program prompts the user and says “there are some unique marketing developments in your type of business, are you interested in purchasing?” Or, the agent program prompts the user and says “we have received a new mailer format which is similar to yours, are you interested?” If the user responds “yes” to any of these questions, the agent program either effectuates the respective request, such as modifying the user's contact list, or provides the requested information to the user or the user's allocated storage for accessible retrieval. This information can be sent directly to remote terminal 10 or stored as an associated field in main database 20.

In another aspect of the present invention, the agent program communicates with remote terminal 10 to ask the user a series of questions to effectuate any of the herein described functions. The user selects an icon generated from website front end 14. The icon is preferably an animate object, conveying an image resembling a living or animated thing. Such animated things include cartoon characters, robots, animals or people. This animated icon gives the user the sense that they are communicating with a living thing, as opposed to merely a computer. Upon selection of the icon, the agent program is executed and begins asking the user the series of marketing questions. Such questions including asking the user if they would like to upload a list or mailer, how many mailings they would like to mail, if they would like to modify their matter or contact list, and any other information required by computer system 8 to effectuate the herein described operations. The user responds, from remote terminal 10, to these questions. The agent program is responsive to the user's answers to these questions from remote terminal 10 to execute the appropriate upload of the contact list mailer, execution of the marketing campaign, or other requested function described herein. The herein described operations are hereinafter referred to as marketing functions.

In another aspect of the invention, the agent program scans the company marketing information to develop marketing criteria. Such criteria includes search terms to run research on a database or on the internet. In one specific example, the agent program scans the company marketing information and determines that the user's customer list contains members located mainly in one geographic area. This information is hereinafter defined as marketing criteria. Next, the agent program executes a search through the customer list database for other contact lists which relate to that particular area. The agent program may also select contact lists which relate directly to that user's business. The agent program then contacts the user, through any of the dissemination methods contained herein, or connects to remote terminal 10, and prompts the user to select or purchase the information, in this example a contact list, which meets this criteria.

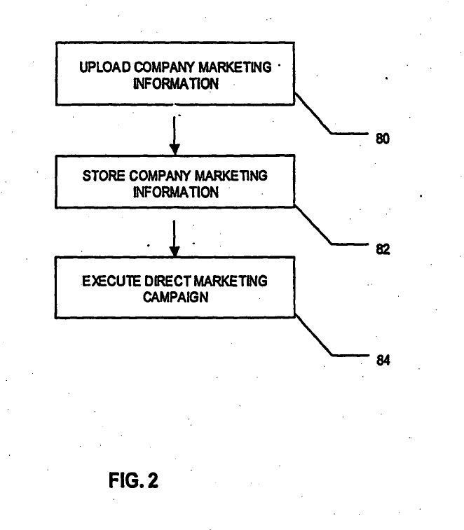

Referring now to FIG. 1 and FIG. 2, the operation of the present invention will now be described. In Block 80, a user first logs on to computer system 8 through website front end 14, through internet 12, from a remote terminal 10. From website front end 14, the user instructs computer system 8 to upload company marketing information into main database storage area 20. In this aspect, company marketing information includes at least a mailer and contact list. Moreover, this material is either loaded from remote terminal 10 or any other previously discussed database. However, this information does not have to be loaded at the same time. Specifically, the contact list can be loaded first. Then, in response to computer system 8, the user can later load a specific mailer from the mailer storage database to execute a direct marketing campaign. Such later upload might be for sending a Christmas card as described previously.

In block 82, the selected contact list is then stored in main database 20. Additionally, the mailer is preferably stored in main database 20. In block 84, a direct marketing campaign is executed using any of the previously discussed dissemination methods including telemarketing 74, fax 72, email 70 or print device 34. To execute this dissemination, the user provides some form of input or request to execute the mailings. Such input can be simply instructing the computer system 8 to execute from remote terminal 10. Alternatively, the user can specify a predetermined time period. Such predetermined time period is associated with the specific contact list and mailer, and the computer system 8 automatically executes the direct marketing campaign on the specified dates or times specified by the user. The contact list is maintained in its respective storage area in main storage database 20 for future executions of direct mailings. Such mailings are for the predetermined time period, or if the user subsequently decides to execute a further direct marketing campaign.

Preferably, in block 84, computer system 8 records a history relating to the executed direct marketing campaign. As such, when the direct marketing campaign is executed, computer system 8 records this execution and information surrounding such execution. Such a history can include dates and times on which campaigns were executed, number of mailers sent, which geographic regions were sent, whom the campaign was directed to, as well as any feedback information provided by the members targeted. This information is stored by computer system 8 in the user's allocated storage area. As such, the user can access this information from remote terminal 10 to use this information and analyze. Alternatively, a user from remote terminal 10 can instruct computer system 8 to tabulate such information into processing area 8 and processes it into report format and then stores the report format in the user's allocated storage area. The users then access the result and can review the report format of the history.

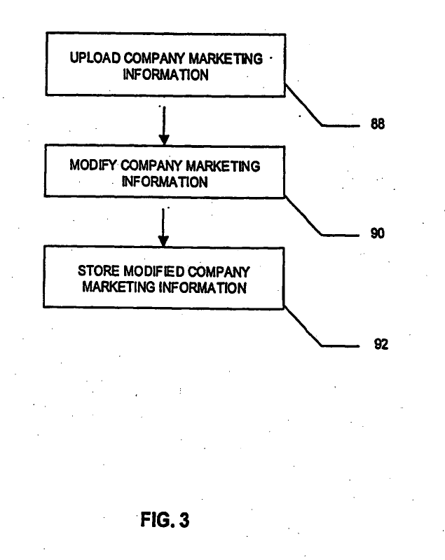

Referring now to FIGS. 1 and 3, company marketing information is modified. Such modification can be for company information, mailer formats as described previously or the contact list. Here, the contact list is modified after being stored in main database storage area 20. Here, in block 88, the user instructs computer system 8 to upload the stored contact list into a processing area, such as either processing area 14 or one located at remote terminal 10. In block 90, the user, from remote terminal 10, then refines the list by adding, deleting or changing a members name or other associated fields as discussed previously. Such modifications may also include purchasing habits of the member, or other characteristics or associated fields. In another aspect, the user also instructs computer system 8 to upload marketing tools into the processing area to process the contact list. With either approach, a modified contact list is generated. Computer system 8 then stores the modified list in the user's allocated storage area in main database 20 in block 92. It is noted that the above described process can also be executed by a response to an agent program or otherwise by computer system 8.

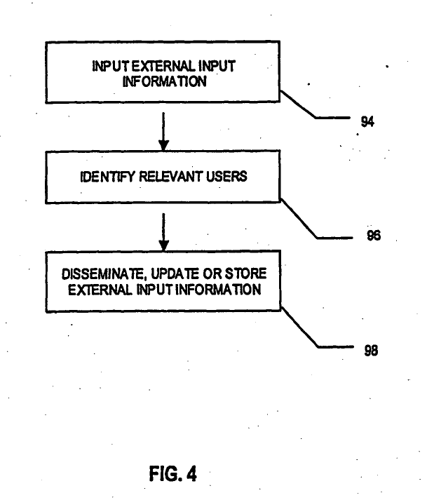

Referring to FIGS. 1 and 4, external input information is input into computer system 8 in block 94, as described previously. This information can be feedback information as described previously, new marketing tips relating to a specific industry, product or service, new contact list for sale, or any other information useful to a user in designing, disseminating a direct marketing campaign or updating a contact list or mailer. In block 96, computer system 8 then determines which contact lists or mailer this information relates. For this purpose, the external input information contains search terms which computer system 8 uses to search through each user's company marketing information and find related users. For instance, for feedback information, computer system 8 searches for the specific user for which the feedback is directed. Such search terms would include address information, computer system 8 searches for the specific user for which the feedback is directed. Such search terms would include address information provided in each disseminated mailer as discussed previously. For a marketing tip, the agent program will look for any user with a business or service that would benefit from the marketing tip. For instance, if the marketing tip related only to the food service, the search term might be food industry. Computer system 8 then, in block 96, scans all relevant fields to identify user's in the food industry. The agent program then determines that this tip is relevant to those specific users. In block 98, computer system 8 either disseminates the information to the relevant user, accessibly stores it in main database 20 for future retrieval by the relevant user, or updates the contact list, mailer or other company marketing information of the relevant user automatically. An agent program, as discussed, preferably carries out this process previously.

For instance, in one example for the above-described process, the external input is the date on which Christmas falls and instructions for computer system 8 to cue relevant users to execute a direct marketing campaign a certain number of days before such a holiday. The external input may also define search terms as any user in the gift business. The agent program also scans information contained in each allocated storage area to ensure that the user has not already effectuated a direct marketing campaign for the particular holiday. The agent program then prompts the relevant users, either through remote terminal 10 or any other dissemination method disclosed herein, to execute a direct marketing campaign. The agent program, or computer system 8, is responsive to replies from the user from remote terminal 10 to execute the suggested direct marketing campaign.

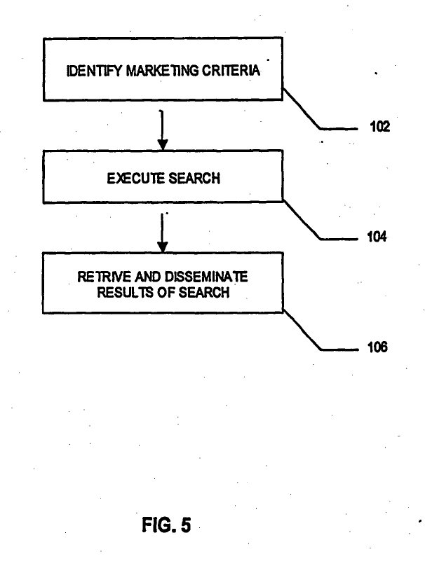

In FIG. 5, computer system 8 reviews company marketing information to develop market criteria in block 102. This market criteria is then used for search terms to search the internet or other searchable databases in block 104. Upon retrieval of information based on this search, in block 106, computer system 106 reports these results by any of the disclosed methods.

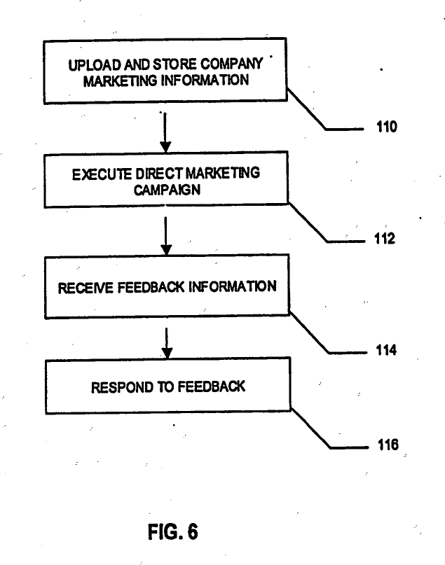

Referring now to FIG. 1 and 6, in block 110, the company marketing information is uploaded and stored in computer system 8. In block 112, a direct marketing campaign is executed. After dissemination, in block 114, computer system receives feedback information from the direct marketing campaign through feedback devices 42A or 42B from the dissemination in block 94 as described previously. Computer system then, in block 116, provides the results as described previously in block 116.

The invention being thus described, it will be obvious that the same may be varied in many ways. Such variations are not to be regarded as a departure from the spirit and scope of the invention. Such variations or modifications, as would be obvious to one skilled in the art, are intended to be included within the scope of the following claims.

1-35. (canceled)

36. A method of direct marketing comprising the steps of:
A. loading a plurality of contact lists and a plurality of mailers into a computer system, each of said contact lists listing a plurality of members and corresponding address fields for executing a direct marketing campaign;
B. storing each of said contact lists in a respective one of a plurality of allocated storage areas in said computer system, each of said allocated storage areas accessible by a respective one of a plurality of allocated users to allow each allocated user to modify or view a respective contact list or execute a direct marketing campaign with a respective contact list;
C. executing a direct marketing campaign with at least one of said contact lists stored in a respective one of said storage areas and one of said mailers, said direct marketing campaign executed in response to input by a respective allocated user to said computer system, said direct marketing campaign disseminating mailers to members on said contact list;
D. maintaining said contact list in said allocated storage area; and
E. executing a second direct marketing campaign with information based on said contact list used in said direct marketing campaign, said information based on said contact list stored in said computer system, said second direct marketing campaign executed in response to input by said allocated user who executed said direct marketing campaign, said input being to said computer system.

37. The method as claimed in claim 36, further comprising executing a plurality of direct marketing campaigns with one of said lists, each of said plurality of direct marketing campaigns executed on a different day, days of executing said plurality of direct marketing campaigns input to said computer system by a respective allocated user of said list for which said plurality of direct marketing campaigns is executed, said computer system reading said days of executing said plurality of direct marketing campaigns and executing said plurality of direct marketing campaigns on each selected day.

38. The method as claimed in claim 36, wherein said computer system prompts said user to execute said direct marketing campaign in response to external input information.

39. The method as claimed in claim 36, wherein said external input information is a listing of important sales dates.

40. The method as claimed in claim 36, further comprising:
comparing said plurality of contact lists with external input information to determine which of said users said external input information relates, users for which said external input information relates being relevant users.

41. The method as claimed in claim 40, wherein said external input information is disseminated by said computer system to each of said relevant users.

42. The method as claimed in claim 36, further comprising:
processing address information or member name information of at least one member contained in a contact list stored in said computer system to form said modified contact list; and
storing said modified contact list in a storage area that is accessible by a respective allocated user of said contact list.

43. The method as claimed in claim 42, wherein said step of processing said address information or member name information is executed by said computer system in response to feedback information from said direct marketing campaign.

44. The method as claimed in claim 42, wherein said step of processing address information or member name information is performed in response to marketing tools.

45. The method as claimed in claim 42, further comprising the steps of:
receiving feedback from said executed direct marketing campaign;
processing said address information or member name information in response to said feedback information to form said modified contact list; and
executing said second direct marketing campaign based on said modified contact list.

46. The method as claimed in claim 36, further comprising the steps of:
receiving feedback information from said executed direct marketing campaign; and
reporting said feedback information to a respective user for which said direct marketing campaign was executed, or storing said feedback information in an allocated storage area accessible by an allocated user for which said direct marketing campaign was executed.

47. The method as claimed in claim 36, further comprising:
reviewing company marketing information to obtain marketing criteria for at least one allocated user, said company marketing information stored in said allocated storage area accessible by a respective allocated user;
executing a marketing search based on said company marketing information; and
reporting results of said marketing search to a respective allocated user.

48. The method as claimed in claim 36, wherein executing said direct marketing campaign comprises:
printing hard copies of said mailer with a printing device, said printing device printing said plurality of hard copy mailers with corresponding address information for each said member; and
disseminating each of said hard copies of said mailers to corresponding members of said contact list through a postal service.

49. The method as claimed in claim 36, wherein executing said direct marketing campaign or said second direct marketing campaign comprises:
sending said contact list and said mailer to a telemarketing group;
using said telemarketing group to contact members of said contact list and orally convey information contained on said mailer to said members.

50. The method as claimed in claim 36, wherein executing said direct marketing campaign comprises sending said mailer to members contained in a respective contact list in electronic format through email.

51. The method as claimed in claim 36, wherein said direct marketing campaign comprises sending mailers to said members via facsimile.

52. The method as claimed in claim 36, wherein said computer system contains a contact list database, said contact list being uploaded from said contact list database in response to a request by a respective allocated user.

53. The method as claimed in claim 36, further comprising:
recording a date history of when prior direct marketing campaigns were executed with one of said plurality of contact lists contained in a respective allocated storage area.

54. The method as claimed in claim 53, wherein said date history is recorded in said allocated storage area for retrieval by a respective allocated user.
